(19) United States
(12) Patent Application Publication
(10) Pub. No.: US 2016/0052593 A1
(43) Pub. Date: Feb. 25, 2016

(54) Universal Platform Adapter For Use With A Bicycle Having A Clipless Pedal

(71) Applicant: Fly Pedals LLC, Denver, CO (US)

(72) Inventors: Daniel Lucchesi, Denver, CO (US); Bryan Gardner, Denver, CO (US)

(73) Assignee: Fly Pedals LLC, Denver, CO (US)

(21) Appl. No.: 14/463,727

(22) Filed: Aug. 20, 2014

(51) Int. Cl. B62M 3/08

(52) U.S. Cl. CPC B62M 3/086

(57) ABSTRACT

A universal platform adapter for use with a clipless pedal on a bicycle includes a body portion having upper and lower surfaces, wherein the upper surface is adapted to be engaged by a generally flat bottom surface of a shoe. A first plurality of attachment apertures is provided in a first arrangement on the lower surface of the body portion and is adapted to cooperate with a first cleat that is adapted for use with a clipless pedal on a bicycle. A second plurality of attachment apertures is provided in a second arrangement on the lower surface of the body portion and is adapted to cooperate with a second cleat that is adapted for use with a clipless pedal on a bicycle. The second arrangement defined by the second plurality of attachment apertures is different from the first arrangement defined by the first plurality of attachment apertures.

### BACKGROUND OF THE INVENTION

This invention relates in general to bicycles having clipless pedals for releasably securing cycling shoes thereto during use. In particular, this invention relates to a universal platform adapter that facilitates the use of a bicycle having clipless pedals by a person wearing conventional flat bottom shoes. Additionally, the universal platform adapter of this invention is readily adapted for use with a plurality of different cleat arrangements on such clipless pedals.

A bicycle is a well known human-powered vehicle that includes a frame having a seat for supporting a rider, front and rear wheels rotatably supported on the frame, a handlebar and fork assembly that allows the rider to steer the front wheel, and a pedal assembly that allows the rider to rotatably drive the rear wheel. A typical pedal assembly includes a crank arm that is rotatably supported on the frame and that supports first and second pedals on opposite sides of the frame for engagement by the feet of the rider during use. The crank arm is connected by a chain or other drive structure to the rear wheel such that rotation of the crank arm (resulting from forces exerted by the feet of the rider on the first and second pedals) rotatably drives the rear wheel to effect movement of the bicycle.

In many instances, the pedals of the bicycle are provided with generally flat surfaces that are adapted to be engaged by correspondingly shaped generally flat bottom surfaces provided on conventional shoes worn by the rider (or by the generally flat bottom surfaces of the bare feet of the rider). These types of bicycle pedals (commonly referred to as platform pedals) provide a relatively large and flat area for the shoes or the feet of the rider to engage. As a result, the rider may comfortably push downwardly in an alternating manner on the pedals so as to rotatably drive the rear wheel of the bicycle in a well known manner.

In other instances, however, it may be desirable for the rider to rotatably drive the rear wheel of the bicycle by not only pushing downwardly on the pedals as described above, but also pulling upwardly on such pedals. To accomplish this, it is also well known to provide cooperating locking structures on cycling shoes worn by the rider and the pedals of the bicycle. These locking structures releasably secure the shoes to the pedals during use. For example, in a bicycle that is provided with conventional clipless pedals, a first attachment structure (commonly referred to as a locking mechanism) is integral with each of the clipless pedals, while a second attachment structure (commonly referred to as a cleat) is secured to the bottom of each of the cycling shoes worn by the rider. The locking mechanisms and the cleats cooperate to releasably secure the shoes worn by the rider to the clipless pedals of the bicycle, thereby allowing the rider to both push downwardly and pull upwardly on the clipless pedals so as to rotatably drive the rear wheel in a continuous manner. The locking mechanisms and the cleats are also designed to quickly and easily disengage from one another (typically when the heels of the cycling shoes are twisted outwardly relative to the clipless pedals by the rider) when the rider wishes to disconnect his feet from the bicycle.

The cleats are usually secured to the cycling shoes worn by the rider by a plurality of bolts or similar threaded fasteners. The number and arrangement of such bolts (as well as the number and arrangement of the holes for such bolts provided in both the cleats and the cycling shoes) vary among different models and brands of the cycling shoes. For example, in some cleats and cycling shoes, two laterally-oriented bolt holes are provided. In other cleats and cycling shoes, three triangularly-oriented bolt holes are provided. These differing arrangements for securing the cleats to the cycling shoes are typically not interchangeable, i.e., a two-hole cleat cannot be secured to a three-hole cycling shoe, and a three-hole cleat cannot be secured to a two-hole cycling shoe.

It can be uncomfortable (and potentially unsafe) for a person wearing conventional flat bottom shoes to ride a bicycle that is equipped with clipless pedals because the locking mechanisms do not provide the relatively large and flat areas for the shoes or the feet of the rider to engage, as described above. However, to remove the clipless pedals from a bicycle and replace them with platform pedals is relatively time consuming and usually requires the use of specialized tools. To address this, it is known to attach adapters having generally flat surfaces to the locking mechanisms of clipless pedals, thereby facilitating the use of a bicycle having clipless pedals for use by a person wearing conventional flat bottom shoes. Unfortunately, known adapters of this type are also relatively time consuming and complicated to install. Additionally, some of such known adapters can only be used with certain cleat installation arrangements, i.e., a two-hole cleat or a three-hole cleat. No known adapters of this type exist that are readily compatible with both a two-hole cleat or a three-hole cleat.

Thus, it would be desirable to provide an improved structure for an adapter that facilitates use of a bicycle having clipless pedals for use by a person wearing conventional flat bottom shoes, and further can be readily used with both two-hole cleat and three-hole cleat arrangements, as well as other different cleat arrangements.

### SUMMARY OF THE INVENTION

This invention relates to a universal platform adapter that facilitates use of a bicycle having clipless pedals for use by a person wearing conventional flat bottom shoes, and further can be readily used with a plurality of different cleat arrangements. The universal platform adapter includes a body portion having an upper surface and a lower surface, wherein the upper surface is adapted to be engaged by a generally flat bottom surface of a shoe. A first plurality of attachment apertures is provided in a first arrangement on the lower surface of the body portion and is adapted to cooperate with a first cleat that is adapted for use with a clipless pedal on a bicycle. A second plurality of attachment apertures is provided in a second arrangement on the lower surface of the body portion and is adapted to cooperate with a second cleat that is adapted for use with a clipless pedal on a bicycle. The second arrangement defined by the second plurality of attachment apertures is different from the first arrangement defined by the first plurality of attachment apertures.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a side elevational view of a portion of a bicycle including a universal platform adapter in accordance with this invention.

FIG. 2 is an enlarged exploded perspective view showing one of the clipless pedal assemblies illustrated in FIG. 1, a conventional two-hole cleat, and the universal platform adapter of this invention.

FIG. 3 is an enlarged exploded perspective view similar to FIG. 2 showing one of the clipless pedal assemblies illustrated in FIG. 1, a conventional three-hole cleat, and the universal platform adapter of this invention.

FIG. 4 is a further enlarged plan view of an upper surface of the universal platform adapter illustrated in FIGS. 1 through 3.

FIG. 5 is an enlarged plan view of a lower surface of the universal platform adapter illustrated in FIGS. 1 through 3.

### DETAILED DESCRIPTION OF THE PREFERRED EMBODIMENT

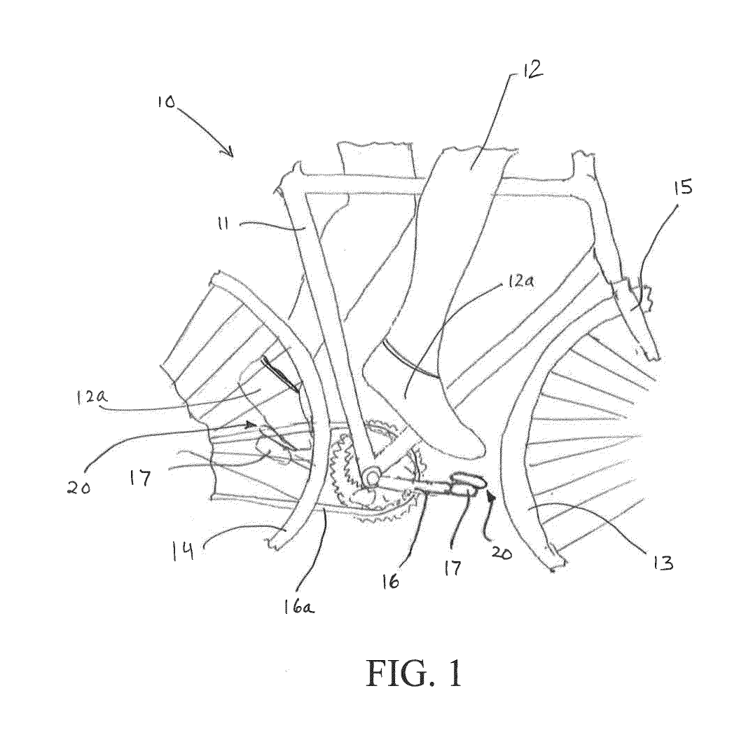

Referring now to the drawings, there is illustrated in FIG. 1 a portion of a bicycle, indicated generally 10. The illustrated bicycle 10 is, of itself, conventional in the art and includes a frame 11 having a seat (not shown) provided thereon for supporting a rider 12 wearing conventional shoes 12a having generally flat bottom surfaces. Front and rear wheels 13 and 14, respectively, are supported on the frame 10 for rotation relative thereto. A handlebar (not shown) and fork assembly 15 is provided on the bicycle 10 and allows the rider 12 to pivot the front wheel 13 relative to the frame 11 such that the rider 12 can steer the bicycle 10 in a desired manner. The illustrated bicycle 10 also includes a crank arm 16 that is rotatably supported on the frame 11. The crank arm 16 is connected by a chain 16a or other drive structure to the rear wheel 14 such that rotation of the crank arm 16 rotatably drives the rear wheel 14 to effect movement of the bicycle 10 in a well known manner.

First and second clipless pedal assemblies 17 are supported on the crank arm 16 on opposite sides of the frame 11. In a manner that is described in detail below, the first and second clipless pedal assemblies 17 are adapted for engagement by the shoes 12a worn on the feet of the rider 12 during use. As is well known in the art, forces can be exerted by the rider 12 on the first and second clipless pedal assemblies 17 to effect rotation of the crank arm 16 and, thus, movement of the bicycle 10. Although this invention will be described and illustrated in the context of the illustrated bicycle 10, it will be appreciated that this invention may be practiced with other types of bicycles or other pedal-operated mechanisms including, for example, stationary exercise cycles, recumbent bicycles, tricycles, and the like.

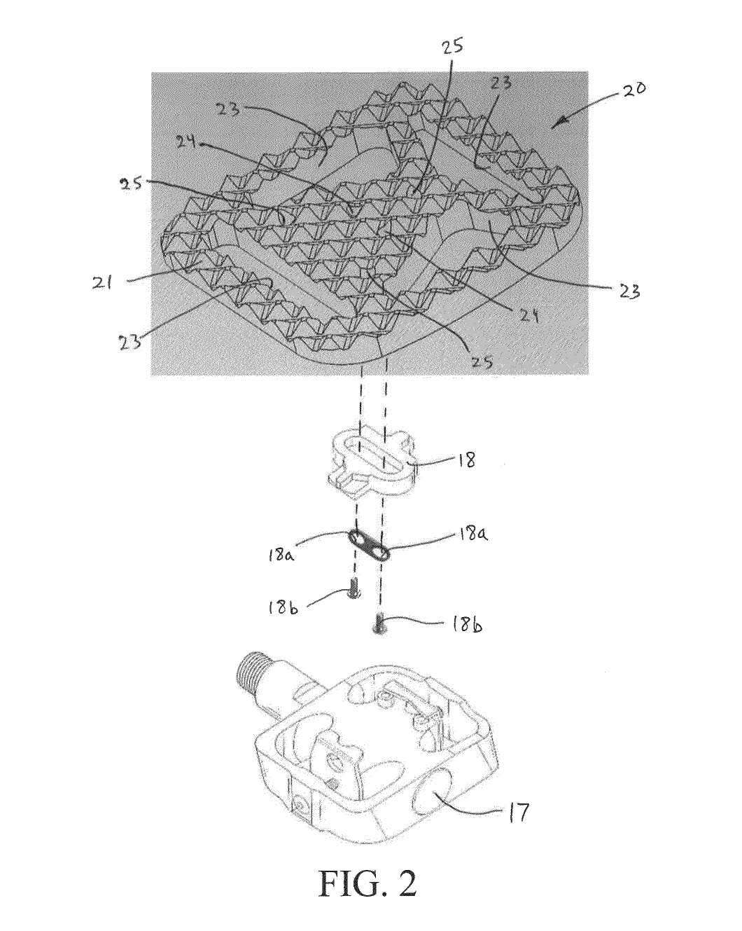

FIG. 2 is an enlarged exploded perspective view showing one of the clipless pedal assemblies 17 of the bicycle 10 illustrated in FIG. 1, together with a conventional two-hole cleat 18 and a universal platform adapter, indicated generally at 20, in accordance with this invention. The two-hole cleat 18 includes a single specialty washer 18a having two laterally-oriented bolt holes. In the past, the two-hole cleat 18 and the specialty washer 18a have been secured to the bottom of a cycling shoe (not shown) worn by the rider 12 for selective attachment to an associated one of the clipless pedal assemblies 17. In accordance with this invention, however, the two-hole cleat 18 is instead secured to the universal platform adapter 20. As a result, the universal platform adapter 20 can be quickly and easily attached to a two-hole type of clipless pedal assembly 17 of the bicycle 10 for use. The structure of the universal platform adapter 20 and the method by which the two-hole cleat 18 is secured thereto will be described in detail below.

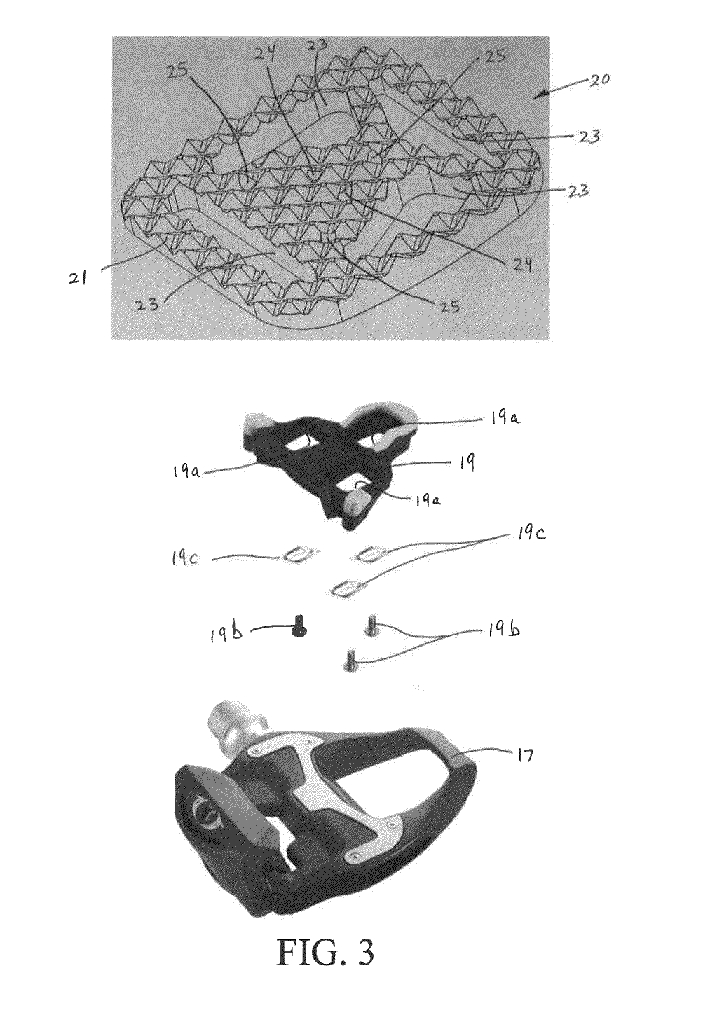

Similarly, FIG. 3 is an enlarged exploded perspective view showing one of the clipless pedal assemblies 17 of the bicycle 10 illustrated in FIG. 1, together with a conventional three-hole cleat 19 and the universal platform adapter 20 in accordance with this invention. The three-hole cleat 19 is provided with three triangularly-oriented bolt holes 19a. In the past, the three-hole cleat 19 has been secured to the bottom of a cycling shoe (not shown) worn by the rider 12 for selective attachment to an associated one of the clipless pedal assemblies 17. In accordance with this invention, however, the three-hole cleat 19 is instead secured directly to the universal platform adapter 20. As a result, the universal platform adapter 20 can also be quickly and easily attached to a three-hole type of clipless pedal assembly 17 of the bicycle 10 for use. The structure of the universal platform adapter 20 and the method by which the three-hole cleat 19 is secured thereto will also be described in detail below.

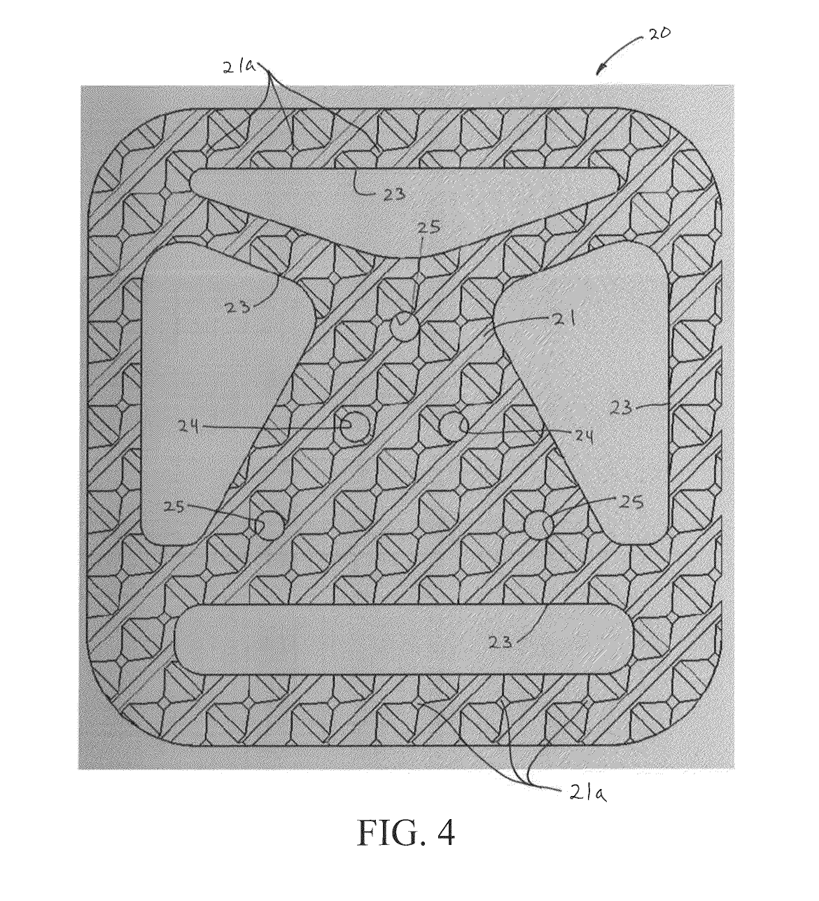

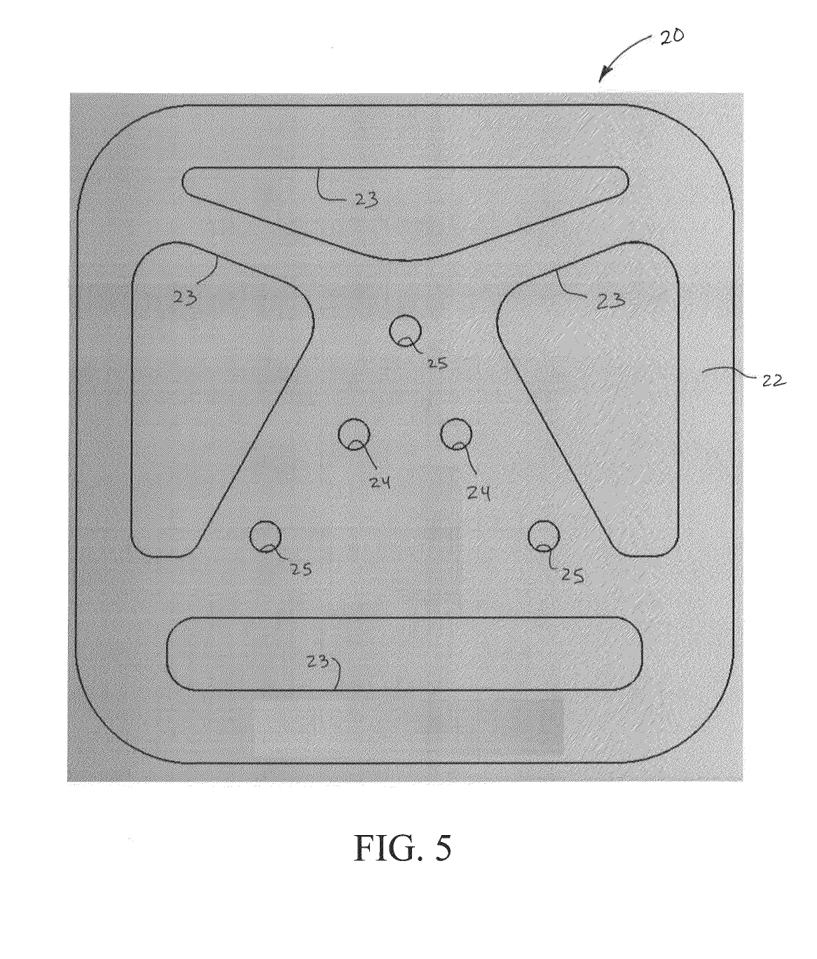

The structure of the universal platform adapter 20 of this invention is illustrated in detail in FIGS. 4 and 5. FIG. 4 illustrates an upper surface 21 of a body portion of the universal platform adapter 20, i.e., the surface 21 of the universal platform adapter 20 that is normally engaged by the generally flat bottom surfaces provided on conventional shoes worn by the rider (or by the generally flat bottom surfaces of the bare feet of the rider). Preferably, the upper surface 21 of the universal platform adapter 20 is textured so as to be relatively slip-free when so engaged. In the illustrated embodiment, the textured upper surface 21 of the universal platform adapter 20 includes a plurality of pyramidal protrusions 21a provided throughout the entire extent of the upper surface 21. However, this invention contemplates that the textured upper surface 21 of the universal platform adapter 20 may include structures having any other shape or combination of shapes, and further that such structures may extend throughout less than the entire extent of the upper surface 21. Alternatively, the upper surface 21 of the universal platform adapter 20 may be provided with none of such structures. The universal platform adapter 20 may be formed from any desired material or combination of materials.

FIG. 5 illustrates a lower surface 22 of the body portion of the universal platform adapter 20, i.e., the surface 22 of the universal platform adapter 20 to which either the two-hole cleat 18 or the three-hole cleat 19 is secured to the universal platform adapter 20 for use. Preferably, the lower surface 22 of the universal platform adapter 20 is not textured, but rather is generally smooth. However, this invention contemplates that the lower surface 22 of the universal platform adapter 20 may include one or more textured structures or combination of structures, and further that such structures may extend throughout some or all of the entire extent of the lower surface 22.

As shown in both FIGS. 4 and 5, the universal platform adapter 20 has a plurality of relatively large openings 23 provided therein for the purpose of reducing the overall weight of the universal platform adapter 20. In the illustrated embodiment, four of such openings 23 extend completely through the universal platform adapter 20 from the upper surface 21 to the lower surface 22. However, this invention contemplates that the universal platform adapter 20 may be provided with a greater or lesser number of such openings 23 (or none at all, if desired), and further that some or all of such openings 23 may be embodied as recesses that do not extend completely through the universal platform adapter 20. Also, the openings 23 may be embodied having any desired shape or combination of shapes.

As also shown in both FIGS. 4 and 5, the universal platform adapter 20 has a plurality of sets of relatively small attachment apertures provided therein for facilitating the securement of either the two-hole cleat 18 or the three-hole cleat 19 thereto. As shown in the illustrated embodiment, a first plurality of such attachment apertures 24 is provided in the universal platform adapter 20 for facilitating the securement of the two-hole cleat 18 to the lower surface 22 thereof. The first plurality of the attachment apertures 24 includes two apertures 24 that are sized and spaced in accordance with the two laterally-oriented bolt holes extending through the specialty washer 18a provided on the two-hole cleat 18. As shown in FIG. 2, the two-hole cleat 18 can be secured to the bottom surface 21 of the universal platform adapter 20 by a pair of bolts 18b or similar threaded fasteners extending respectively through the bolt holes of the specialty washer 18a into engagement with the first plurality of the attachment apertures 24 of the universal platform adapter 20. Thus, it can be seen that the universal platform adapter 20 can be quickly and easily adapted for use with clipless pedal assemblies 17 using two-hole cleats 18.

As also shown in the illustrated embodiment, a second plurality of such attachment apertures 25 is also provided in the universal platform adapter 20 for facilitating the securement of the three-hole cleat 19 to the lower surface 22 thereof. The second plurality of the attachment apertures 25 includes three apertures 24 that are sized and spaced in accordance with the three triangularly-oriented bolt holes 19a provided on the three-hole cleat 19. As shown in FIG. 3, the three-hole cleat 19 can be secured to the bottom surface 21 of the universal platform adapter 20 by three bolts 19b or similar threaded fasteners extending respectively through conventional washers 19c and the bolt holes 19a. Thus, it can be seen that the universal platform adapter 20 can be quickly and easily adapted for use with clipless pedal assemblies 17 using three-hole cleats 19.

In operation, the bicycle 10 is initially provided with a pair of the clipless pedal assemblies 17 that, as discussed above, are normally intended for use with cycling shoes having either two-hole cleats 18 or three-hole cleats 19. To adapt the bicycle 10 for use with conventional flat bottom shoes, the desired two-hole cleats 18 or three-hole cleats 19 (depending upon the type of clipless pedal assemblies 17 that are provided on the bicycle 10) are initially secured to the bottom surfaces 21 of the universal platform adapters 20 in the manner described above. Preferably, this is accomplished by obtaining a spare set of such two-hole cleats 18 or three-hole cleats 19, which would obviate the need to remove the two-hole cleats 18 or three-hole cleats 19 from the cycling shoes 12a. Regardless, however, by installing the appropriate two-hole cleats 18 or three-hole cleats 19 thereon, the universal platform adapters 20 can be quickly and easily installed on the clipless pedal assemblies 17 provided on the bicycle, thereby quickly and easily allowing the bicycle 10 to be used with conventional flat bottom shoes.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A universal platform adapter for use with a clipless pedal on a bicycle comprising:
a body portion having an upper surface and a lower surface, wherein the upper surface is adapted to be engaged by a generally flat bottom surface of a shoe;
a first plurality of attachment apertures provided in a first arrangement on the lower surface of the body portion and adapted to cooperate with a first cleat that is adapted for use with a clipless pedal on a bicycle; and
a second plurality of attachment apertures provided in a second arrangement on the lower surface of the body portion and adapted to cooperate with a second cleat that is adapted for use with a clipless pedal on a bicycle, wherein the second arrangement defined by the second plurality of attachment apertures is different from the first arrangement defined by the first plurality of attachment apertures.

2. The universal platform adapter defined in claim 1 wherein the upper surface of the body portion is textured.

3. The universal platform adapter defined in claim 1 wherein the first plurality of attachment apertures extends completely through the body portion from the upper surface to the lower surface.

4. The universal platform adapter defined in claim 3 wherein the second plurality of attachment apertures extends completely through the body portion from the upper surface to the lower surface.

5. A combined universal platform adapter and cleat assembly for use with a clipless pedal on a bicycle comprising:
a body portion having an upper surface and a lower surface, wherein the upper surface is adapted to be engaged by a generally flat bottom surface of a shoe;
a first plurality of attachment apertures provided in a first arrangement on the lower surface of the body portion;
a second plurality of attachment apertures provided in a second arrangement on the lower surface of the body portion, wherein the second arrangement defined by the second plurality of attachment apertures is different from the first arrangement defined by the first plurality of attachment apertures; and
a cleat that is attached to the lower surface of the body portion by fasteners cooperating with either the first plurality of attachment apertures or the second plurality of attachment apertures, wherein the cleat is adapted for use with a clipless pedal on a bicycle.

6. The combined universal platform adapter and cleat assembly defined in claim 5 wherein the upper surface of the body portion is textured.

7. The combined universal platform adapter and cleat assembly defined in claim 5 wherein the first plurality of attachment apertures extends completely through the body portion from the upper surface to the lower surface.

8. The combined universal platform adapter and cleat assembly defined in claim 5 wherein the second plurality of attachment apertures extends completely through the body portion from the upper surface to the lower surface.

9. A method of installing a universal platform adapter and cleat assembly on a clipless pedal on a bicycle comprising the steps of:
(a) providing a universal platform adapter including a body portion having an upper surface and a lower surface, wherein the upper surface is adapted to be engaged by a generally flat bottom surface of a shoe; a first plurality of attachment apertures provided in a first arrangement on the lower surface of the body portion; and a second plurality of attachment apertures provided in a second arrangement on the lower surface of the body portion, wherein the second arrangement defined by the second plurality of attachment apertures is different from the first arrangement defined by the first plurality of attachment apertures; and
(b) attaching a cleat to the lower surface of the body portion by fasteners cooperating with either the first plurality of attachment apertures or the second plurality of attachment apertures, wherein the cleat is adapted for use with a clipless pedal on a bicycle.

10. The method defined in claim 9 wherein step (a) is performed by providing the upper surface of the body portion with a textured surface.

11. The method defined in claim 9 wherein step (a) is performed by providing the first plurality of attachment apertures extending completely through the body portion from the upper surface to the lower surface.

12. The method defined in claim 11 wherein step (a) is performed by providing the second plurality of attachment apertures extending completely through the body portion from the upper surface to the lower surface.
